(19) United States
(12) Patent Application Publication
(10) Pub. No.: US 2005/0010438 A1
(43) Pub. Date: Jan. 13, 2005

(54) Method and system for obtaining payment for healthcare services using a healthcare note servicer

(76) Inventors: Victor C. York, Houston, TX (US); Lawrence York, Lexington, KY (US)

Correspondence Address: FULBRIGHT & JAWORSKI, LLP, 1301 MCKINNEY, SUITE 5100, HOUSTON, TX, 77010-3095, US

(21) Appl. No.: 10/618,236

(22) Filed: Jul. 11, 2003

(51) Int. Cl. G06F 17/60

(52) U.S. Cl. 705/2

(57) ABSTRACT

The disclosed invention provides a method and system for obtaining payment for services provided to a patient by a healthcare operator using a healthcare note servicer. The patient executes a finance agreement with the provider, and the agreement is managed by the servicer. This finance agreement is executed without regard to the patient's credit history. The servicer sends periodic credit card styled statements to the patient requesting payment, thereby elevating the status of the obligation. The servicer collects principal, interest, and fees, and sends all or substantially all of the collected principal amount to the healthcare provider.

### FIELD OF THE INVENTION

This invention provides a method for obtaining payment for healthcare services using a healthcare note servicer.

### BACKGROUND

The healthcare industry incurs high costs in maintaining, servicing, and recovering self-pay/co-pay accounts receivable arising, for example, from non-insured patients or from the deductible amounts charged to insured patients. In hospitals with active emergency rooms or extensive out-patient services, the self-pay/co-pay accounts receivable may be 15% to 30% of the total accounts receivable. These percentages are expected to increase as the increase in insurance costs causes some people to choose high deductibles and others to forgo health coverage completely. Traditionally the burden for these costs has been placed on the healthcare providers rather than on the patients, which places the healthcare industry in a unique position with regard to the credit extended to their customers. In virtually no other service industry can a customer receive benefits without payment or without a firm obligation for payment.

Although healthcare providers may outsource as many as 100,000 accounts each year to collection agencies, those accounts generally have an average balance of less than $1000. The reason for non-payment is often not an inability to pay or even a lack of intent to pay but rather is the lack of a firm obligation to pay and a formal structure for collecting payments. Healthcare obligations are not generally perceived as having the same status as other debts such as, for example, credit card payments or automobile loans.

Various solutions have been proposed to deal with the problem of uncompensated care in the healthcare industry. Some providers have adopted a credit card program in which patients apply for a credit card on which to charge their unpaid balances. However, approval rates in such programs may be as low as 10%, which means that such programs are not suitable for the majority of self-pay/co-pay situations.

Other providers have resorted to factoring, in which all of the self-pay/co-pay accounts receivable are immediately sold at a discount. Such arrangements typically include a provision for recourse back to the healthcare provider if the full amount is not collected within a certain time period. Thus, under this type of program the healthcare provider will not receive the full amount due for any self-pay/co-pay invoice unless that invoice is paid in full when the patient is discharged. Also, for recourse factoring, the healthcare provider continues to be an active participant in the collection process.

Other providers have adopted an automatic debit approach in which periodic payments are automatically debited from the patient's bank account. However, such programs typically do not include a firm obligation for repayment, and patients are able to cancel the automatic debit at any time.

Other healthcare providers have adopted in-house financing and/or in-house collection programs in an attempt to manage and collect unpaid self-pay/co-pay receivables. Such providers may have patients sign a note agreement when they are unable to pay their balance in full. If the note is not paid in full within a certain period of time, then it may be written off, may be referred to an in-house collection department, or may be outsourced to a collection agency. However, this approach places the cost of financing and collection on the healthcare provider rather than on the patient where it belongs. Further, many healthcare providers are unwilling or unable to fund extensive in-house programs for financing and/or collection. Moreover, these programs may not have an integrated, systematic monitoring, maintenance, and payment collection process.

What is needed is an in-house financing program for healthcare providers that (1) is a simple template-based turnkey system, (2) is accessible over the Internet and/or through point of sale terminals, (3) is potentially applicable to all patients regardless of their credit history, (4) shifts the cost of credit from the provider to the patient, (5) elevates the status of the obligation in the eyes of the debtor, (6) eliminates the active role of the healthcare provider in the credit maintenance and collection process, and (7) is easily integrated within existing health care provider systems.

### SUMMARY OF INVENTION

The present invention provides a healthcare in-house patient finance system in which the provider of healthcare services uses a system enabling the provider to internally structure a finance arrangement for the uninsured portion or self-pay/co-pay amount of a receivable, thereby eliminating or greatly reducing the internal and external cost of servicing and collecting such receivables.

Generally, most methods in use by the healthcare provider are limited in their ability to service the vast majority of the uninsured patient community. Various means of financing methods and procedures exist for the over-qualified and under-qualified patient from a reimbursement perspective. Numerous qualifying finance programs are available from third parties offering recourse debt purchasing, line of credit lending, healthcare credit card offerings, factoring, as well as from the public sector where financial assistance programs are available through, for example, the Medicaid system.

While many programs are available to adjudicate a provider's receivables, none has come close to eliminating the high cost associated with the self-pay/co-pay receivable. The result is that the nations' healthcare providers continue to incur expense from the delivery of the healthcare service as well as from the cost of recovery. This cost includes, but is not limited to, staffing, sending statements, office expenses, management expenses, outsourcing costs, and collection agency costs in order to recover debts that are owed and that are the responsibility of the patient or of his or her guarantor. This unfortunate dilemma is the result of inadequate front end procedures, policies, applications, and systems to establish or define and control the relationship regarding the “purchase” of healthcare services at the point of service.

Generally, those patients with healthcare insurance coverage may have a patient deductible or co-pay amount. The amount of that obligation therefore is determined or estimated readily upon verification of insurance. Patients that have no insurance, but for which the provider offers treatment, have a self-pay amount due that typically will not be paid at the time of service by the patient without a credit vehicle available to them, i.e., a credit card or a line of credit. This is the case for a substantial number of the uninsured or for many patients who have deductible amounts that are not covered by their insurance company. This situation most often lends itself to a provider having a large majority of its self-pay/co-pay patients leave the provider after receiving services without a formal agreement for payment of services. Because of this, most providers carry the self-pay/co-pay balance on their books accepting whatever payments are paid. Many providers establish loose arrangements at discharge that fail to be met, resulting in the provider outsourcing the account for follow up and monitoring assistance or later referring the account to a collection agency for collection. Some providers even use a secondary agency and even a tertiary agency in an attempt to recover the self-pay/co-pay obligations. The result is a systemic loss on services rendered that reduces cash flow and profitability to the provider.

The present invention provides a streamlined procedure and process for formalizing the arrangement of payment back to the provider. The system enables the provider to gain commitment on the amount of the self-pay/co-pay obligation. The provider, using a template, determines the willingness of the patient to pay and assists in arriving at a periodic payment satisfactory to the patient and to the provider, which will pay out the account in terms acceptable to both parties. A contract is drawn from the resulting terms keyed into the template, and the agreement is created and signed by the patient/guarantor. That document is transmitted to a servicer for account management. The provider no longer has the responsibility to service or collect the account. The debtor makes payments from statements sent periodically by the servicer, and the servicer periodically reports to the provider all payment activity; transmitting actual payments by EFT directly into the provider's designated account. The provider in turn, at the point of service and upon finalizing the paperwork with the patient, collects a set up fee from the patient, which fee may be debited by the servicer from a designated provider account on a periodic basis. Although the patient sends payments to the servicer, the patient is not “paying” the servicer in the sense that the obligation is to the servicer. Instead, the obligation is to the provider, and the servicer is receiving payments from the patient on behalf of the provider.

The in-house patient finance system may be delivered by the servicer in a variety of ways. For example, it may be delivered through the installation of proprietary software on the provider's PC workstations in locations as desired by the provider such as registration, emergency room, admission office, and/or discharge. The PC's may be connected to the Internet to enable the delivery of the patient finance agreements to the servicer's server for initiation of support services contemplated through the debt servicing arrangement authorized by the patient.

Alternately, the system may be delivered using a software application delivered through “point of sale” terminals (POS). The code for this application may be programmed into nationally marketed and distributed multi-functional terminals such that the contract can be signed by the patient/guarantor with a stylus on a pad that captures the signature (electronic signature). All related data and information along with the patient finance agreement may be transmitted to a data warehouse and stored for future reference. The data, once received by the servicer, will be stored on a server and processed. Statements will be initiated, and monitoring, maintenance, and management of the collection of each patient account throughout the recovery process will begin. In another embodiment, the POS terminal may accept partial payment and/or payment of the set-up fee from a “Stored Value Card” either at the point of service and/or for installment payments pursuant to the patient finance agreement.

The present invention provides numerous benefits to the patient. For example, the patient is assisted in establishing credit where no previous credit existed in that the servicer may report to the Credit Reporting Agencies (“CRA”) the payment status of the patient paying the account. A good payment history will result in a favorable credit score at a CRA. Also, there is no credit check required to qualify for the terms offered by the provider. The present invention also establishes a meaningful financial relationship between the patient and the provider. The patient has an option that allows a pay-off of the account within the terms of the patient finance agreement with no interest charge. The disclosed system makes repayment available at generally more favorable terms and a lower interest rate than the cost of credit using traditional credit cards or lines of credit. Monthly credit card styled statements assist the patient in organizing scheduled payments. The invention thus provides flexibility to enable the patient to pay for health care services at payments that he or she is capable and willing to pay over an extended period of time. The invention also provides a system by which the “un-bankable” and those without credit can pay their debt.

In addition, the present invention provides certain benefits to the provider. Specifically, the system makes possible and establishes a solid financial relationship with the patient. The system elevates the priority and importance of the obligation resulting in greater frequency of payments and lower projected default rates. Further, the system redistributes the cost of the extended terms for repayment to the patient who is using repayment terms to meet his or her healthcare needs. The system also reduces outsourcing costs and collection agency costs as well as potential legal fees associated with enforcing payment, and it reduces the bad debt expense related to lost revenue on self-pay/co-pay receivables. The disclosed system eliminates the costs associated with internally servicing the self-pay/co-pay receivable debt, and it provides additional and faster cash flows from the monitoring, servicing, and professional management of the term payment receivable debt for the provider. Further, the provider benefits by having the payment service points convenient and accessible over the Internet and by ATM's that accept various credit/debit cards and stored value cards. (These cards may store information magnetically or on enclosed integrated circuits and may include biometric authentication features.) The provider receives a turn key system from the servicer at little or no cost. Further, the patient finance system can be made available in a stand alone PC based system, an Internet based system, an on-line system, or through a point of sale risk based terminal, a tablet PC, and/or a PDA (Personal Digital Assistant) offering total health care financial point of service capabilities and making ease of use and training simple and adaptable to any point of service.

### BRIEF DESCRIPTION OF FIGURES

FIG. 1 illustrates a finance worksheet that may be used in accordance with the present invention.

FIG. 2 illustrates a patient information worksheet that may be used in accordance with the present invention.

FIG. 3 illustrates a guarantor information worksheet that may be used in accordance with the present invention.

FIG. 4 illustrates a monthly statement that may be used in accordance with the present invention.

FIG. 5 is a flow chart illustrating certain embodiments of the present invention.

FIG. 6 is a chronology illustrating certain aspects of the present invention.

### DETAILED DESCRIPTION

The present invention will be described below in terms of a sequence of steps. These steps are presented for the purpose of illustrating certain embodiments of the invention. Other embodiments may perform certain of these steps in a different order, may not require that all of these steps be performed, or may perform certain steps in parallel.

Step A: Bill Presented at Time of Discharge

A patient receives services from a healthcare provider and, at the time of discharge, is presented with a bill for those services. This bill may be for the full amount if the patient is uninsured or may be for the deductible amount if a portion of the bill is to be paid by insurance.

Step B: Patient Declines to Pay Full Amount Due

If the patient is unable or unwilling to the pay the full balance due at the time of discharge, then the healthcare provider collects information from the patient using a series of templates or worksheets. (The terms “template” and “worksheet” are used interchangeably herein. Also, the term “patient” as used herein is a broad term that includes, for example, the guardian of a minor patient, who may also be the guarantor.)

Step C: Finance Worksheet is Completed

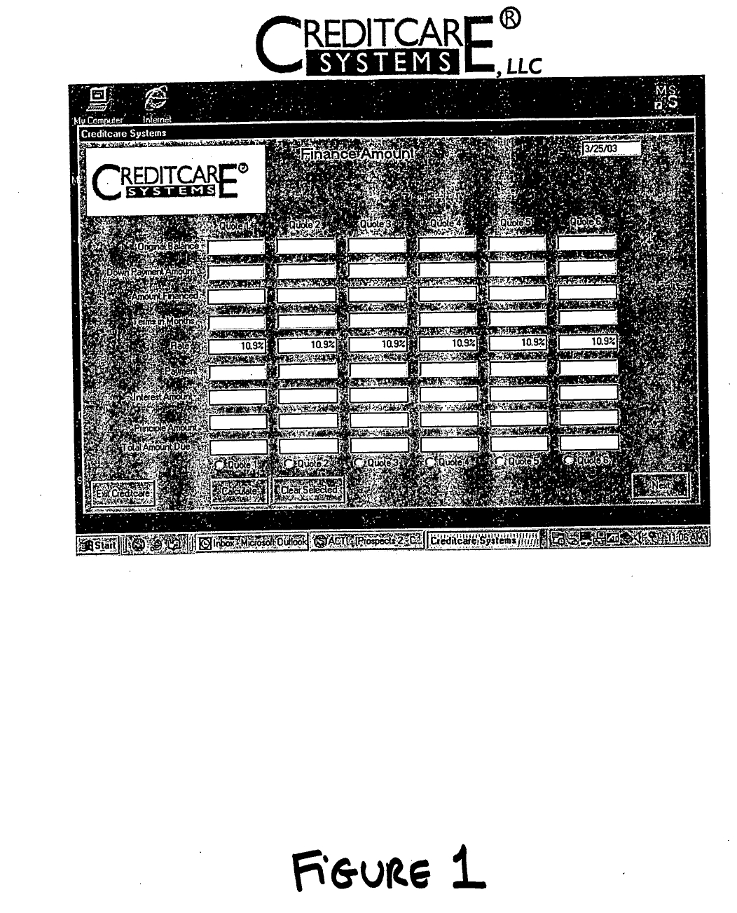

The patient provides information requested on a finance worksheet. A sample finance worksheet is shown in FIG. 1. This worksheet is used in part to determine the interest rate, the periodic payment amount, and the duration of the obligation. Preferably, the patient is queried regarding the maximum monthly payment that he or she is able to afford, and that information may also be used in part to determine these values. Other factors may be used as well to influence the interest rate, and these factors may include, for example, geography, provider subsidies, automatic periodic payment authorization, etc. An optional down-payment may also be collected at this time to reduce the financed amount. Preferably, the periodic payment is a monthly payment, but other periods may be used. (The terms “periodic” and “periodically” are not necessarily used herein in a strict mathematical sense, but instead refer simply to events that occur at regular or irregular intervals of time.)

Typically the amount due at the time of discharge from a healthcare facility is only an estimate of the ultimate amount owed by the patient. The actual amount may change, for example, depending on the amount that is actually paid by insurance coverage. In such cases, the patient is informed that the amount shown on the finance agreement is an estimate of the amount owed and that the actual balance will be determined at a later date.

Although handled by the servicer, the obligation is between the provider and the patient. The servicer dictates neither payment amounts nor duration. The transfer of funds among the servicer, the patient, and the provider may occur in a variety of ways. For example, a setup fee may be collected by the provider from the patient at the point of service and then be transmitted to the servicer along with the patient and/or guarantor information worksheets and the patient financing agreement. A point of sale terminal, tablet PC, and/or PDA may be used in such an embodiment to run the patient finance application and accept payment by credit card, check, stored value card, or automatic debit (ACH). In a second embodiment, the funds may be deposited directly by the provider into the servicer's bank account, and the financing agreement may be transmitted to the servicer via a web site over the Internet. Under this embodiment, the servicer could debit the provider's bank account to collect fees for financing agreements received during a previous predetermined time period. In a third embodiment, the financing agreement could be printed by the provider, acknowledged by the patient, and faxed or mailed to the servicer. The setup fee could then be collected from the patient, with the servicer periodically debiting the provider's bank account to collect the setup fees.

Step D: Patient Information Worksheet is Completed

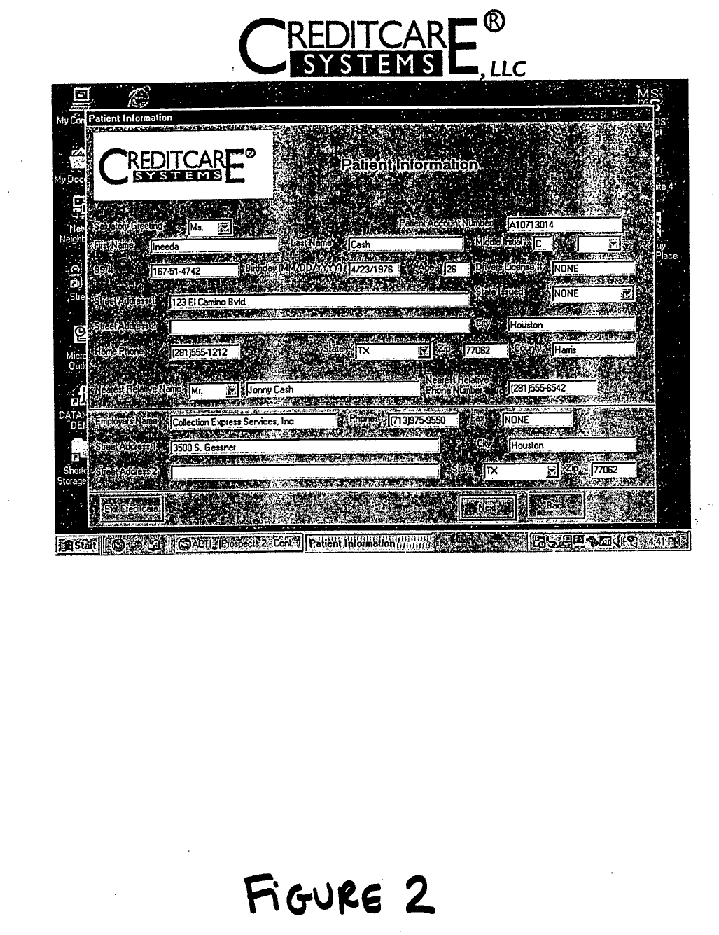

The patient provides information requested on a patient information worksheet. A sample patient information worksheet is shown in FIG. 2. This patient information may alternately be obtained automatically from information collected earlier, for example, at the time the patient was first admitted to the healthcare facility, during pre-registration, during registration, during admission, during emergency room procedures, and/or during discharge. The information may be transferred to the patient information worksheet using a “screen scrape,” that is, by lifting data from a source database and using it to populate pre-defined fields in a destination database. The patient may be queried regarding his or her willingness to pay the obligation and his or her employment and/or ability to pay the obligation.

Step E: Guarantor Information Worksheet is Completed

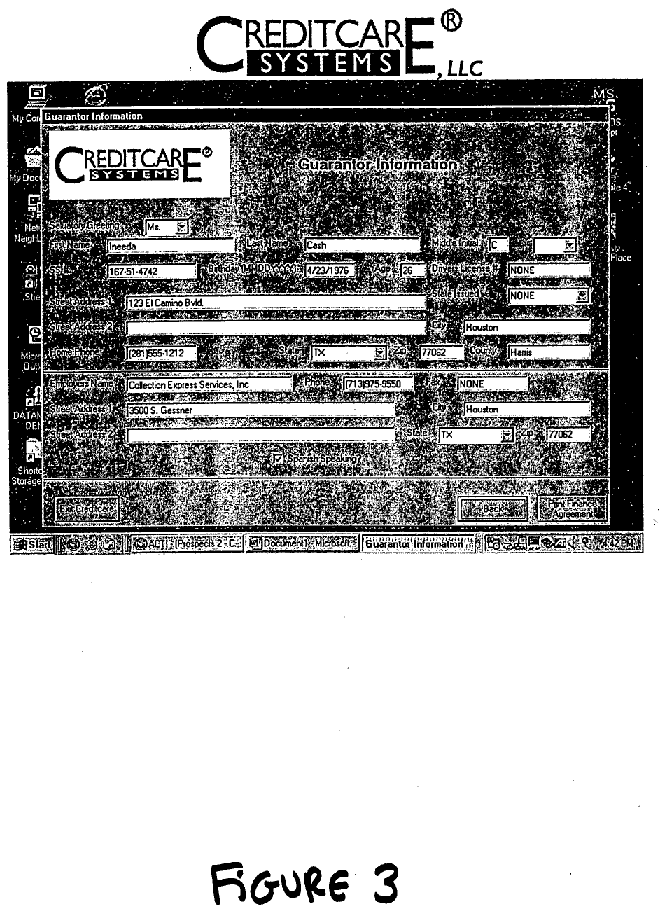

The patient provides information requested on a guarantor information worksheet. A sample guarantor information worksheet is shown in FIG. 3. This worksheet collects information regarding the party that will ultimately be responsible for the payments. For example, if the actual patient is a minor, then the guardian of the minor patient may be the guarantor. Preferably, a dialog box appears asking whether the patient is also the guarantor. If yes, then the information from the patient information worksheet may be used to populate the guarantor information worksheet, either manually or automatically. If no, then the new information is collected. Preferably, the patient is also asked whether his or her primary language is English. If not, then an appropriate foreign language disclosure statement is printed and provided to and acknowledged by the patient.

Step F: Finance Agreement is Populated and Executed

The information on the finance worksheet, patient information worksheet, and guarantor information worksheet is used to populate a finance agreement. This finance agreement is between the patient and the provider, but is made available through and managed by the servicer. That is, the provider retains and owns its receivable debt. The servicer services the obligation on behalf of the provider, but the servicer may or may not obtain title to the obligation. (The term “servicer” as used herein is a broad term that includes, for example, affiliates and subsidiaries of the healthcare provider itself, and may even be the same as the healthcare provider itself. The servicer may be a third party, may be the provider or an affiliate of the provider, and may encompass out-sourced services provided by, for example, a collection agency, a bank or other financial institution, or a third party operating a data warehouse.) Further, this finance agreement is executed without regard to and without access to the credit history of the patient. The information placed into these templates may be stored locally or may be stored on a remote server accessed, for example, over a secure data line or secure Internet connection directly to the servicer.

The agreement may be signed remotely using an electronic signature pad, tablet PC, PDA, or other ID authentication device connected through a wired, dial-up, Internet, or wireless connection. Certain provisions in the patient finance agreement and, if appropriate, the foreign language acknowledgement agreement may also be initialed electronically using the aforementioned devices. Alternately, the executed agreement may be mailed or faxed to the servicer. Any information required by law, such as, for example, bilingual placards or truth-in-lending information may be presented to the patient during this step. The patient is preferably provided a printed copy of the agreement showing the patient's signature. The agreement may then be electronically submitted to a data warehouse, which may image the agreement and load the information into a finance system operated by the servicer that will manage the obligation. Specifically, the agreement and the data together with the initials and signature(s) are electronically transmitted preferably using at least 128 bit HIPAA (Health Insurance Portability & Accountability Act) compliant encryption technology to deliver the data to a data warehouse and server for processing by the servicer.

Importantly, the patient finance agreement is executed without regard to the patient's credit history. However, collection scoring mechanisms may be used on the back-end of the system to separate the self-pay/co-pay receivable debt into categories for forecasting provider cash flows and collections. Certain categories of debt scored by the probability of payment may be settled by a factoring arrangement.

A sample finance agreement for use in accordance with the present invention is attached as Appendix A.

Step G: Patient Receives Periodic Credit Statements

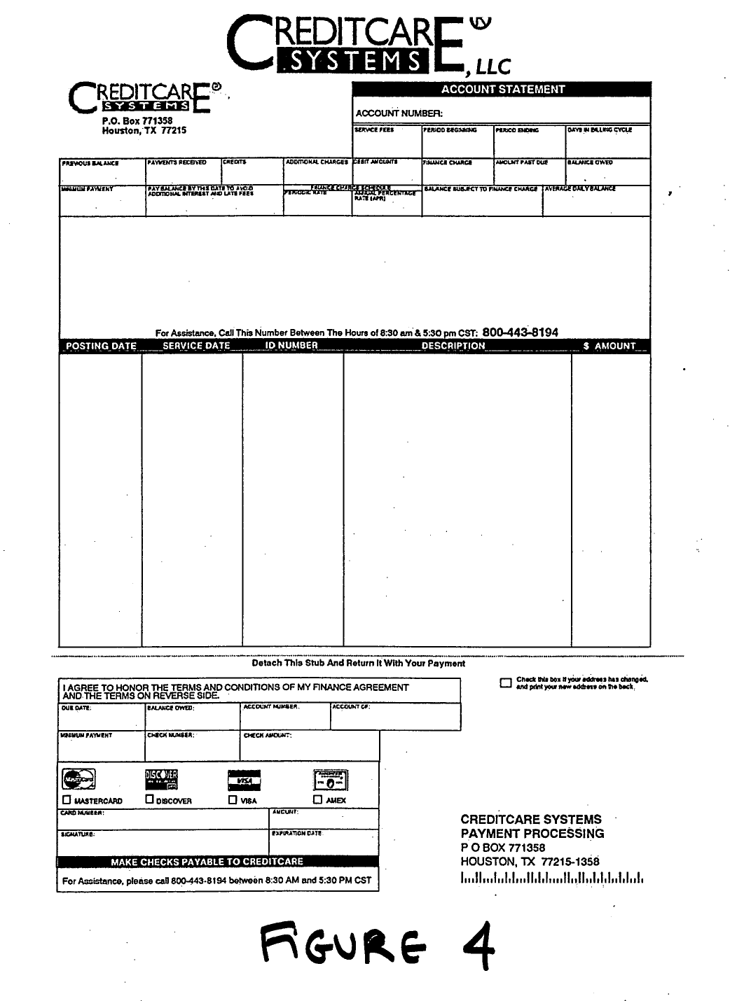

The servicer periodically prepares and sends credit statements to the patient requesting the agreed periodic payments, preferably monthly. A sample periodic “credit card styled” statement is shown in FIG. 4. These statements include interest charges as well as any penalties that may be due to previous late payments or under-payments, and they are provided sufficiently in advance of the payment due date. Other fees that may be collected include insufficient check charges and/or other fees for services that are requested by the patient, including, for example, check-by-phone fees and other convenience fees or document fees (amortization schedule, copy of finance agreement, pay-off statement, etc.). These statements are preferably credit card styled; that is, they are designed to resemble typical credit card statements. The statements are sent by the servicer, and payment is sent to and processed by the servicer. The healthcare provider plays no role in the processing and collection of these periodic payments.

Step H: Healthcare Provider Receives Payment for Services

Once payment is received by the servicer, an agreed upon portion is sent to the healthcare provider. Preferably, the servicer retains the interest and penalty fees while sending the entire collected principal to the healthcare provider. The servicer may also specify a minimum retained service fee and then retain the interest or the minimum fee, whichever is greater.

The provider may agree to pay or advance the setup fee, in which case the setup fee may be subtracted from the amount provided by the servicer back to the provider, or it may be added to the amount owed by the patient. Also, the servicer may in some embodiments retain a portion of the collected principal, or the provider may receive a portion of the collected interest and/or fees.

Step I: Unpaid Accounts Are Outsourced for Collection

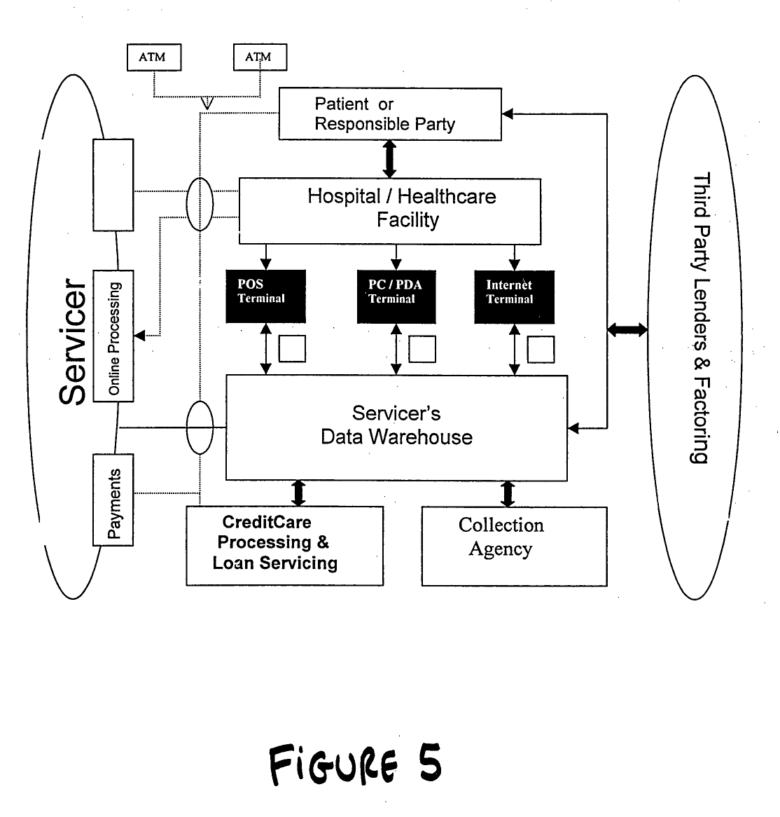

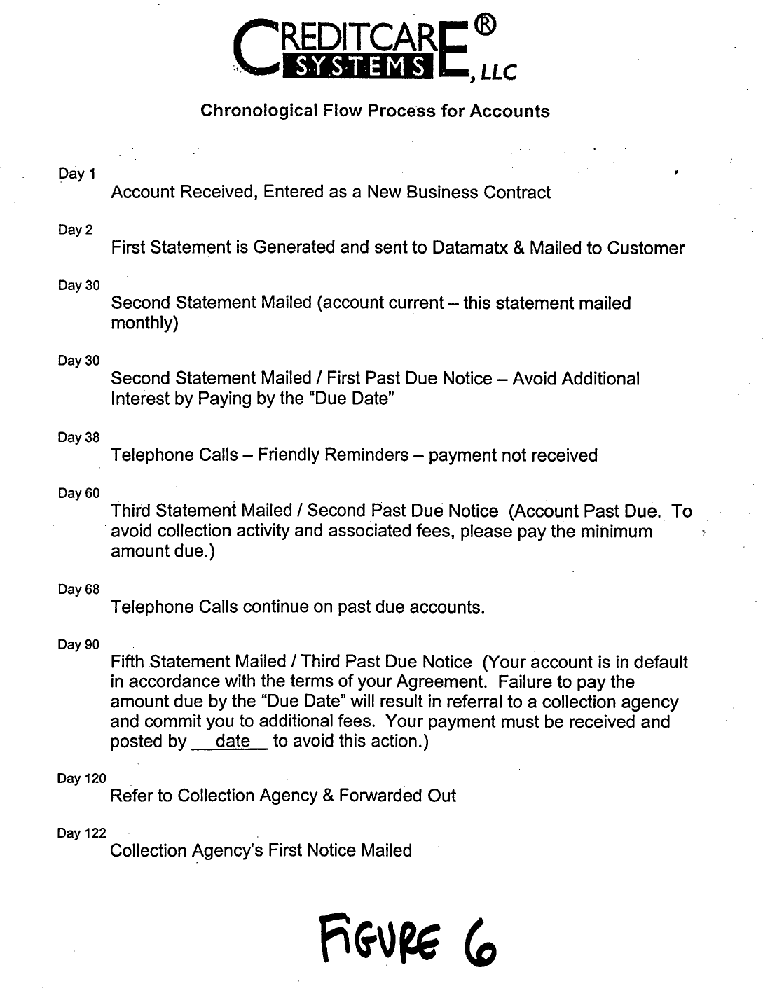

If full payment is not received within a set time period, the servicer may outsource the obligation to a collection agency, but again the healthcare provider incurs no cost and plays no role in this outsourcing step other than to receive an agreed portion of whatever payments may be ultimately collected. For example, 30 days notice may be sent to the patient following 90 consecutive days of non-payment, and, after a total of 120 days, the obligation may be placed for collection. A flow chart illustrating the steps of certain embodiments of the present invention is shown in FIG. 5, and a sample chronology is shown in FIG. 6.

The provider will be given notice of accounts that are in default and that are being referred for collection. Once forwarded to selected collection agencies, the servicer will manage the process, audit and collect from the agencies, and remit collected funds to the provider. The patient in accordance with their patient finance agreement pays the collection costs. The agreement may specify a method by which the patient can determine what the collection cost will be upon event of default. Additionally, the servicer may have a network of attorneys nationwide with which to forward accounts requiring payment to be enforced. This capability may be specifically allowed for in the patient finance agreement.

The provider retains title to the receivable debt subject to agreements between the servicer and the provider and between the patient and the provider. No factoring is involved in the arrangement between the provider and the servicer. The servicer distributes accounts as authorized by the provider, adds a collection fee as agreed to by the patient, and, if necessary, places the account with an affiliated or third party debt collector pursuant to The Fair Debt Collection Practices Act (“FDCPA”). When or if such funds are collected, the servicer transmits the appropriate portion to the provider, taking into account the portion retained by the third party debt collector. The servicer is responsible for auditing and monitoring the payments due to the provider.

Step J: Benchmarking Receivables

The servicer may analyze payment data to track receivables and provide benchmarking reports to the healthcare provider. These benchmarking results may, for example and as described above, be used to score and categorize future self-pay/co-pay receivable debt. These scores and associated reports may be provided to the provider in various formats, including various graphical formats, and may be made available in “real time” on a secure web site or on the provider's computer systems.

### Additional Detailed Description

The disclosed system is a complete, turnkey system. The system elevates the payment priority for healthcare receivables by making it debt, which results in a higher level of repayment for healthcare services. The interest paid by the patient covers the cost of servicing the contract for the healthcare provider, which receives all or a substantial portion of the amount billed for healthcare services. The servicer preferably retains the interest charges and/or the administrative fees authorized by the provider for servicing the healthcare receivable debt. Thus, the operating costs for the healthcare provider are significantly reduced or eliminated. Finally, the cost of credit extended is paid by the patient consumer, which greatly reduces or eliminates the costly outsourcing fees and collection agency fees that are typically a routine and significant cost to healthcare providers.

Personnel from the servicer may optionally provide training to personnel from the healthcare provider. This training may be hands-off or hands-on, and may be directed to facility admissions, registration, and/or other personnel.

A point of sale terminal, tablet PC, or PDA may be used to implement certain of these steps. Preferably, software to implement these steps will be programmed into a multi-tasking device that provides additional services such as eligibility determinations, insurance verification, check verification, credit card processing, loan processing, Automated Clearing House (ACH) transaction processing, and authentication.

Certain embodiments of the present invention are directed for use over the Internet. The Internet consists of a large number of computers connected via network links and communicating via standardized Internet protocols to form a global, distributed network. Eventually, the Internet will connect most every device having a unique IP address for continuous communication (IPV6). While the term “Internet” as used herein is intended to refer to what is commonly known today as the Internet, it is also intended to encompass future embodiments of the Internet as well as private and public networks and any variations to those networks that may exist in the future, including changes and additions to existing standard protocols.

Computer users communicate and exchange information over the Internet using standardized protocols. The World Wide Web (“WWW”) provides a visual interface to facilitate this communication and exchange of information. The WWW allows a server computer, having set up a web site, to send text and graphical images in the form of web pages to a client computer for display or storage. Devices with an IP address may send and receive communications and information over the Internet.

Web pages are typically written using Hyper-Text Markup Language (“HTML”). The software on the client computer that interprets and executes the commands contained in web pages is called a browser. In this context, the “client” denotes the computer using a browser to request and display information and the “server” denotes the computer responding to those requests by providing web pages. A single web page may contain data from a number of different servers. Examples of browsers include the Microsoft Internet Explorer and the Netscape Navigator as well as browsers designed for handheld devices operating under the Windows CE (Pocket PC) or Palm operating systems. The client indicates to the browser a desire to view a particular web page by entering that web page's address, which is referred to as its Uniform Resource Locator (“URL”), into the browser. The browser then initiates a client computer request to a server asking that it transfer to the client the HTML file that defines the requested web page. When the requested web page is received by the client, the browser uses it to construct a visual image of the web page on the client's display monitor or to store a visual image of the web page on the client's computer. The web page contains various commands for displaying text, graphics, controls, background colors, and other display features. In addition, the web page may contain other URL addresses, called hot links, that point to other web pages at the server's web site or other web sites. In addition, web pages may contain form fields or other devices that permit the client to transmit data to the server computer and may contain audio or video objects as well. A web page may be larger than the image displayed on the client computer's monitor, in which case the browser supplies scroll bars that permit the client to view different portions of the web page.

Web page description languages other than HTML are either currently available or planned for future release. In addition, various extensions to the basic HTML standard have been developed to provide additional features. These extensions include WebBot components, Java applets, browser plug-ins, Dynamic HTML (“DHTML”), and ActiveX controls. These and other extensions permit web pages to offer capabilities and services far beyond that offered by HTML alone. Methods for using these and other extensions to design web pages are well known in the art.

A browser communicates with a web server over a transmission link that operates according to the Transmission Control Protocol/Internet Protocol (“TCP/IP”). For the majority of Internet communications, a browser communicating with a server over a TCP/IP link sends and receives information using the Hyper-Text Transfer Protocol (“HTTP”). Most web browsers also enable clients to access server resources and services using additional protocols such as File Transfer Protocol (“FTP”) and Telnet.

Communication between a client and server generally takes place over communication links such as telephone lines and public network lines that are not inherently secure. Two important security issues related to client-server communications are privacy and authentication. Privacy involves prohibiting anyone other than the intended recipient from being able to read a communication between the client and the server. Privacy is typically accomplished using cryptographic methods by which communications are encrypted prior to transmission and decrypted subsequent to receipt. One popular protocol for providing an encrypted communication link between the server and the client is the Secure Sockets Layer (“SSL”) protocol developed by Netscape Communications Corp. This protocol is typically referred to as the HTTPS protocol. Other security protocols are available, including Private Communications Technology (“PCT”), Secure Hyper-Text Transport Protocol (“SHTTP”), and Pretty Good Privacy (“PGP”). Methods for using these and other protocols to provide secure Internet connections are well known in the art.

A second important security issue related to client-server communications is authentication. Authentication involves verifying that the entity with whom a client (or server) is communicating is in fact the actual server (or client). One method of authentication uses certificates to authenticate a message. A certificate is a set of digital data that identifies an entity and verifies that the public encryption and signature keys included within the certificate belong to that entity. Methods of providing authentication are well known in the art.

Currently, the primary standard protocols for allowing applications to locate and acquire Web documents are HTTP and HTTPS, and the Web pages are encoded using HTML. However, the terms “Web” and “World Wide Web” as used herein are intended to encompass future markup languages and transport protocols that may be used in place of or in addition to HTML, HTTP, or HTTPS. Further, the term “Web” as used herein is a broad term including, for example, the hardware and software server components as well as any non-standard or specialized components that interact with the server components to provide services to Web site users.

An Internet enabled embodiment of the present invention will allow patients and providers who enter into financing agreements to access and maintain those accounts over the Internet and, specifically, over the World Wide Web if desired. Services available to the patient over the Internet include, for example, a history of payment activity, current balance, last payment amount and date, and an E-Payment portal for making payments securely (which will require a password, a user ID, and an authorization method that verifies the party using the site). Access over the Internet may also provide a forum to communicate requests and notify the servicer of problems or difficulties. Further embodiments include an ability for the patient to request that statements be sent by e-mail. The web site over the Internet may also inform the patient on such subjects as the servicer's privacy policy under HIPAA (and as related to their (PHI) Protected Health Information) as well as the servicer's policy on privacy under the Graham-Leach-Bliley Act. The patient may also be allowed to schedule future payments through ACH authorization procedures using the Internet. The web site may also provide patients the opportunity to pay by check either directly or by referring them to a telephone number they can call if they desire to speak to someone about their account and payment plans. Preferably, the transactions posted to the Internet will be uploaded and processed within 24 hours of receipt. Patients will also be allowed to make payments over the Internet to a secure payment processing site so that the patients may control the timing of when their payments are submitted to the bank for processing. Prior to access into the system over the Internet, the provider, patient, and/or the guarantor are preferably required to “click through” an acknowledgement that he or she has read and agreed to a license agreement governing use of the web site and/or software.

Various receivable/debt reports may be provided to the provider from the servicer. These reports may be provided periodically or may be specifically requested by the provider over the Internet. These reports include, for example, accounts receivable debt reports, late charge reports, aging reports, interest reports, name change reports, paid account reports, projected income reports, benchmark scoring reports, transaction reports, past due balance reports, and/or past due payment reports.

A health care provider may, for political reasons in the community either due to being a not for profit, county, or tax based health care provider or simply not wishing to be or appear to be more aggressive than their corporate competitor in the community, decide that it is desirable to offer the a patient finance system in accordance with the present invention but in which the provider subsidies the interest so that the patient actually pays little or no interest. In this embodiment, the health care provider would agree to pay a percentage to the servicer or agree to establish the interest at a lower than offered or market rate, which they offer to their patients, and which they pay the difference to the servicer. For example, the health care provider on an 11% rate might pay 9.1% and offer the patient community a 1.9% rate. In this way, the health care provider would be able to ease the community into the concept of paying interest on their healthcare obligations. In another embodiment, the health care provider may agree to pay a percentage of each payment that was not paid but which the servicer was required to service. Such embodiments permit the provider to reduce costs and implement a patient finance system in accordance with the present invention.

Certain aspects of the detailed description of the present invention are presented in terms of procedures, steps, logic diagrams, and other symbolic and descriptive representations that depict the operations of data processing devices connected via networks. These process descriptions and representations are the methods used by those experienced or skilled in the art to most effectively convey the substance of their work to others skilled in the art. Certain steps require the physical manipulation of electrical signals that are capable of being stored, transferred, combined, compared, displayed, or otherwise manipulated in a computer system or network. For convenience and clarity these electrical signals may be referred to as bits, values, digital signals, elements, symbols, operations, messages, terms, numbers, images, or the like. All of these and similar terms are merely convenient labels and are to be associated with the appropriate electrical signals to which they correspond. Unless specifically stated or otherwise apparent from the description, the terms “processing,” “computing,” “displaying,” and the like refer to actions and processes of a computing system and network that manipulates and transforms data represented by electrical signals within the computing device's memory, where the term “memory” includes ROM, RAM, magnetic storage media, optical storage media, and the like.

The present invention, therefore, is well adapted to carry out the objects and obtain the ends and advantages mentioned above, as well as others inherent herein. All presently preferred embodiments of the invention have been given for the purposes of disclosure. Where in the foregoing description reference has been made to elements having known equivalents, then such equivalents are included as if they were individually set forth. Although the invention has been described by way of example and with reference to particular embodiments, it is not intended that this invention be limited to those particular examples and embodiments. It is to be understood that numerous modifications and/or improvements in detail of construction may be made that will readily suggest themselves to those skilled in the art and that are encompassed within the spirit of the invention and the scope of the appended claims.

1. A method for obtaining payment for services provided by a healthcare provider to a patient via a servicer, comprising:
said servicer receiving from said healthcare provider a finance agreement between said patient and said healthcare provider executed without access to said patient's credit history in which said patient agrees to make a periodic payment to said servicer;
said servicer periodically sending to said patient a request for said periodic payment;
said servicer periodically receiving from said patient a payment; and,
said servicer periodically sending to said healthcare provider a portion of said collected payment.

2. The method of claim 1 wherein said periodic payment is a monthly payment.

3. The method of claim 1 wherein said request is a credit card styled statement.

4. The method of claim 1 wherein said collected payment includes a principal amount and an interest amount and wherein said portion includes said principal amount.

5. The method of claim 1 wherein said collected payment includes a principal amount and an interest amount and wherein said portion excludes said interest amount.

6. The method of claim 1 further comprising:
said provider completing a finance worksheet with information obtained from said patient;
said provider completing a patient information worksheet with information obtained from said patient; and,
said provider populating said finance agreement with information from said finance worksheet and said patient information worksheet.

7. The method of claim 6 further comprising said provider completing a guarantor information worksheet.

8. The method of claim 1 wherein said finance agreement is executed remotely using a network connection between said healthcare provider and said servicer.

9. The method of claim 8 wherein said network connection is an Internet connection.

10. The method of claim 8 further comprising the step of remotely obtaining said patient's signature over said network connection using an ID authentication device.

11. A system for obtaining payment for services provided by a healthcare provider to a patient via a servicer, comprising:
a finance agreement between said patient and said provider executed without access to said patient's credit history;
a first transmission means for transmitting said executed finance agreement to said servicer;
a collection means for periodically collecting payment from said patient according to said finance agreement's terms; and,
a second transmission means for transmitting a portion of said periodically collected payment to said provider.

12. The system of claim 11 wherein said first transmission means comprises electronic transmission over an Internet connection.

13. The system of claim 11 wherein said collection means comprises credit card styled account statements.

14. The system of claim 11 wherein said second transmission means comprises an electronic funds transfer.

15. A method for collecting a self-pay/co-pay debt obligation owed to a healthcare provider by a patient using a servicer, comprising:
said healthcare provider executing a finance agreement with said patient for said self-pay/co-pay obligation without access to said patient's credit history;
said healthcare provider transmitting said finance agreement to said servicer;
said servicer sending a credit card styled request to said patient for payment according to said finance agreement's terms;
said servicer receiving said payment from said patient, wherein said payment comprises a principal portion and an interest portion; and,
said servicer transmitting said principal portion to said healthcare provider.

16. The method of claim 15 wherein said servicer is an affiliate of said healthcare provider.

17. The method of claim 15 wherein said receiving step comprises receiving an electronic payment from a patient accessing a World Wide Web site over the Internet.

18. The method of claim 15 wherein said receiving step comprises receiving an electronic payment from a patient using a Stored Value Card.

19. The method of claim 15 wherein said healthcare provider transmitting step comprises transmitting said finance agreement electronically by accessing a World Wide Web site over the Internet.

20. The method of claim 15 further comprising the steps:
said servicer scoring a plurality of patients based on their payment habits;
said servicer creating a report summarizing the results of said scoring step;
said servicer transmitting said report to said provider; and,
said provider creating a score for said patient and modifying said finance agreement's terms based on said report and said score.
